(19) United States
(12) Patent Application Publication
(10) Pub. No.: US 2019/0392047 A1
(43) Pub. Date: Dec. 26, 2019

(54) MULTI-TABLE PARTITIONS IN A KEY-VALUE DATABASE

(71) Applicant: Amazon Technologies, Inc., Seattle, WA (US)

(72) Inventor: James Christopher Sorenson, III, Seattle, WA (US)

(73) Assignee: Amazon Technologies, Inc., Seattle, WA (US)

(21) Appl. No.: 16/017,913

(22) Filed: Jun. 25, 2018

(51) Int. Cl. G06F 17/30; G06F 3/06

(52) U.S. Cl. CPC G06F 17/30132; G06F 17/30109; G06F 17/30094; G06F 3/067; G06F 17/30215; G06F 3/0614; G06F 3/0644

(57) ABSTRACT

Multi-table partitions may be implemented for a key-value database. Items in tables of the database may be assigned storage locations in partitions of the key-value database according to a same partitioning scheme so that different items from different tables may be stored in the same partition. When requests to access a table are received, the partitioning scheme may be applied to identify which partition to access for the requests. A table index structure may be maintained to identify the items in a table.

### BACKGROUND

Database systems managing large amounts of data on behalf of users may distribute and/or replicate that data across two or more machines, often in different locations, for any of a number of reasons, including security issues, disaster prevention and recovery issues, data locality and availability issues, etc. As the scale of data stored increases, database systems may implement different techniques for distributing and replicating data that can cope with the increasing demand upon data storage resources to provide highly performant access to data while still preserving the various management features that contribute to data availability and durability. Thus, such techniques for distributing data in a database system, like distributing data across different partitions, may be highly desirable.

### BRIEF DESCRIPTION OF THE DRAWINGS

FIG. 1 is a logical block diagram illustrating multi-table partitions in a key-value database, according to some embodiments.

FIG. 2 is a logical block diagram illustrating a provider network offering a database service that may implement multi-table partitions in a key-value database, according to some embodiments.

FIG. 3 is a logical block diagram illustrating a request router for that routes access requests to storage nodes storing a data as part of a key-value database with multi-table partitions, according to some embodiments.

FIG. 4A is a table index structure for a table stored in multi-table partitions in a key-value database, according to some embodiments.

FIG. 4B is a secondary index structure stored in multi-table partitions in a key-value database, according to some embodiments.

FIGS. 5A-5C illustrate example access requests to a request router for a table stored in multi-table partitions in a key-value database, according to some embodiments.

FIG. 6 is a high-level flowchart illustrating various methods and techniques to implement multi-table partitions in a key-value database, according to some embodiments.

FIG. 7 is a high-level flowchart illustrating various methods and techniques to perform access requests to a table stored in multi-table partitions in a key-value database, according to some embodiments.

FIG. 8 is a high-level flowchart illustrating various methods and techniques to cache portions of an index structure for a table stored in multi-table partitions in a key-value database, according to some embodiments.

FIG. 9 is a block diagram illustrating an example computing system, according to some embodiments.

While embodiments are described herein by way of example for several embodiments and illustrative drawings, those skilled in the art will recognize that the embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION

The systems and methods described herein may be employed in various combinations and in various embodiments to implement multi-table partitions in a key-value database, according to some embodiments. Distributed data storage systems, such as key value databases, may utilize partitions in various embodiments, in order to increase the availability, reliability and performance of the key-value database. Partitions, for example, may allow for requests accessing multiple different items of data to parallelize the work among different partitions, in some embodiments. Partitions may allow for a greater number of resources for processing requests to be allocated to a smaller number of items (e.g., smaller partition size at a host system allows for allocation of more host system resources to processing access requests to the smaller partition), in some embodiments. Multi-table partitions may be implemented to distribute the workload for requests more evenly amongst individual partitions so that users of the key-value database do not have manage resource allocation to handle workloads that overburden individual partitions, in some embodiments. In this way, the performance of the key-value database is improved as overburdened resources are reduced, limiting the collateral impact that one overburdened resource can have on other key-value database resources. Additionally, scaling of database tables may be more seamlessly and transparently performed as the likelihood that any data added for any one table to cause a partition split or other data movement to accommodate the additional data is smaller (amortizing the cost for distributing data more widely and thus more cheaply to users of the key-value database and to the system itself which can more efficiently use storage capacity, reducing waste), in some embodiments.

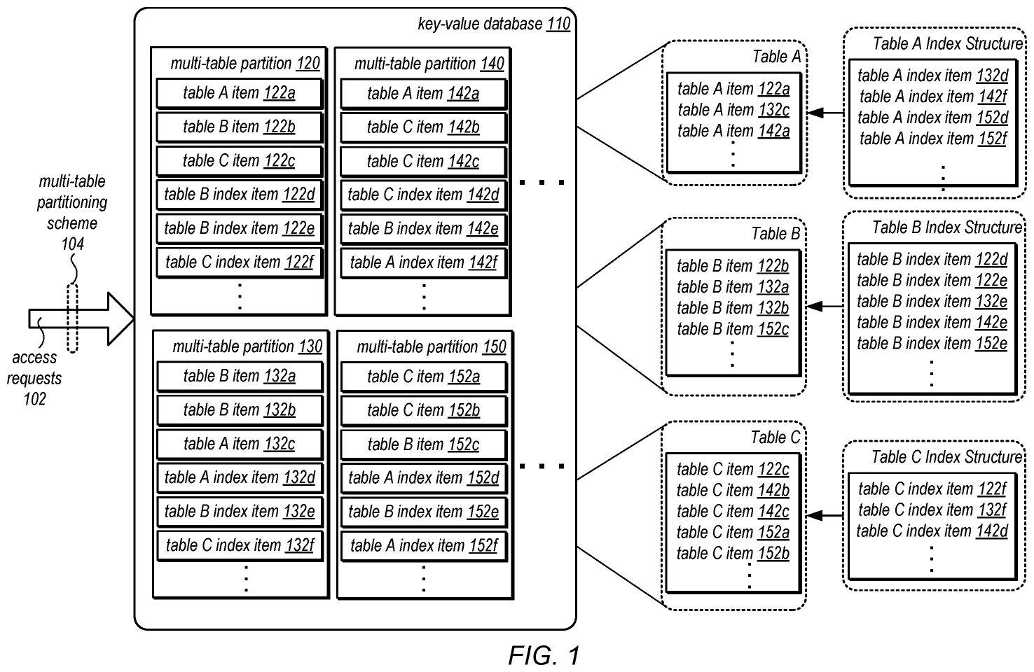

FIG. 1 is a logical block diagram illustrating multi-table partitions in a key-value database, according to some embodiments. Key-value database 110 may store collections of data objects (e.g., records, rows, entries, or other items) in different respective tables, in some embodiments. Tables may be non-relational, semi-structured or otherwise organized to not enforce an exact same schema (e.g., same number of attributes) on each item stored as part of the table, in some embodiments. Multi-table partitioning may be implemented for key-value database 110 to store items for tables in partitions on a per-item basis (or item-level partitioning granularity as opposed to table-level partitioning granularity), in some embodiments. Instead of excluding all items from a partition except those items in a single database table, multi-table partitions may be assigned to store many different items from many different tables according to the multi-table partition scheme, in some embodiments.

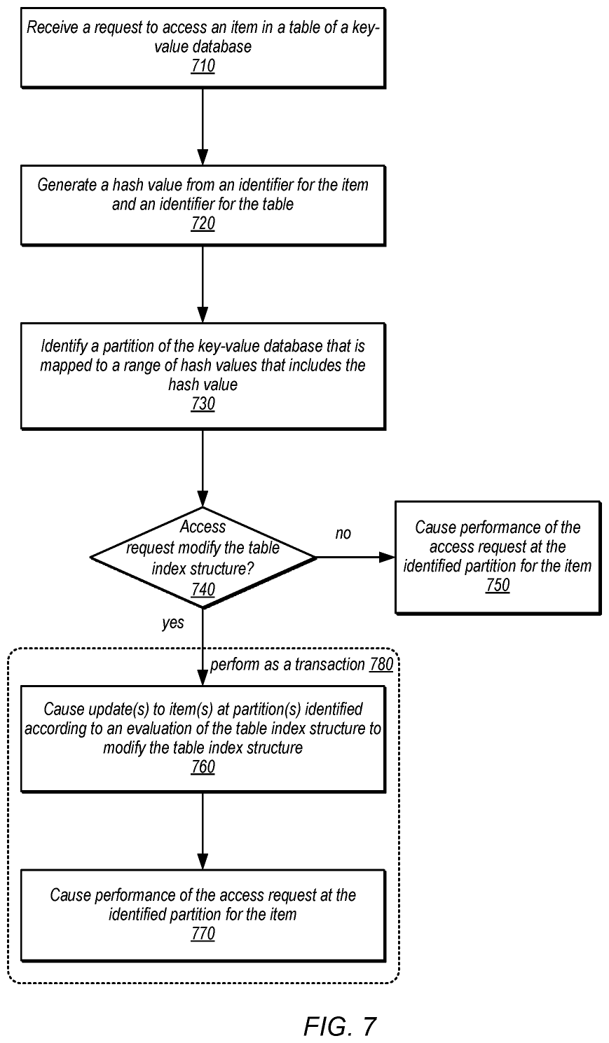

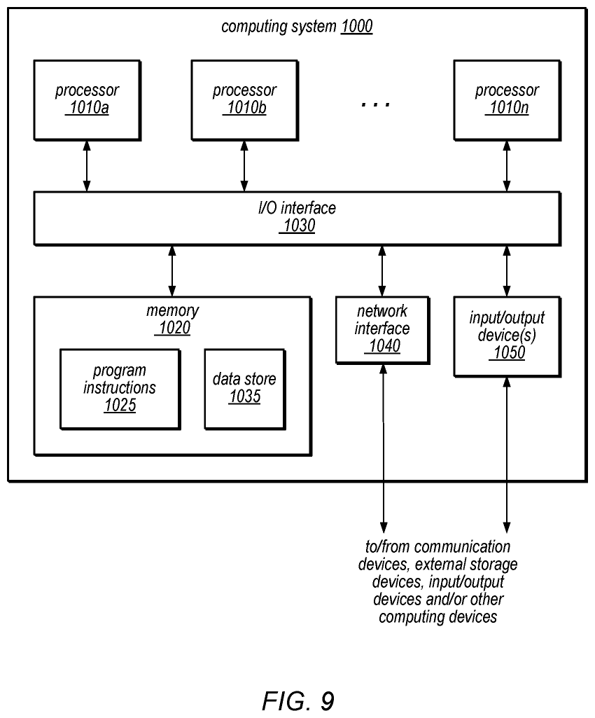

For example, in FIG. 1, three different tables, table A, table B, and table C each may have different respective items (e.g., items 122a, 132c, and 142a for table A, items 122b, 132a, 132b, and 152c for table B, and items 122c, 142b, 142c, 152a, and 152b for table C). Multi-table partitioning scheme 104 may store or otherwise assign the items to different partitions of key-value database 110, such as multi-table partitions 120, 130, 140, and 150. Different types of mapping schemes that prevent collisions between similarly valued items that are stored in different tables may be implemented. For example, in at least some embodiments, a distributed hashing scheme that generates hash values for items using an item identifier and table identifier, as discussed in more detail below with regard to FIG. 7, may be implemented (e.g., by applying a cryptographic hash function such as Secure Hash Function (SHA) or other type of hash function). Multi-table partitions may, in various embodiments, be portions or all of one or more storage devices (e.g., hard disk drives, solid state drives, memory devices, etc.). Multi-table partitions may be stored or managed by separate nodes (e.g., separate host systems, such as computing system 1000 in FIG. 9), in some embodiments.

Access requests 102 to key-value database 110 for one or multiple items in a table in key-value database 110 may be performed according to multi-partitioning scheme. For requests that access a single item, such as a request to read, get or otherwise obtain an item, multi-part partitioning scheme 104 may be applied to identify the partition for the request item.

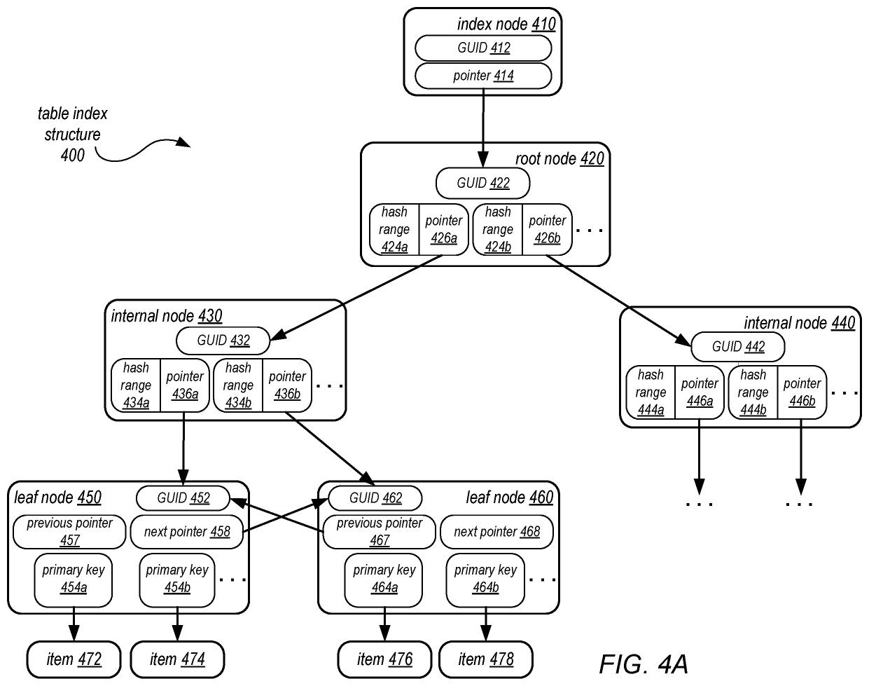

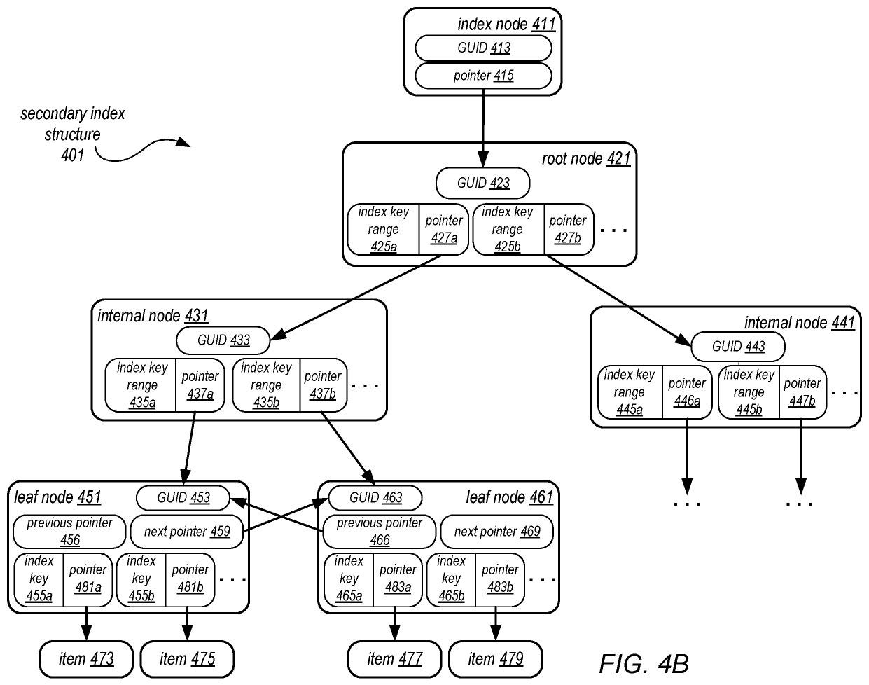

In at least some embodiments, access requests to access multiple items for a single access request may be supported. Such requests, such as a query to a table for certain items or a scan for certain items may have to access some or all items currently stored in table. Instead of relying upon storage locations such as partition that only stores data from 1 table in order to perform the access requests, an index structure for a table may be implemented that identifies the members of a table separate from their storage location (e.g., partition), in some embodiments. Different index structures may be implemented, such as the example tree table index structure discussed below with regard to FIGS. 4A and 4B.

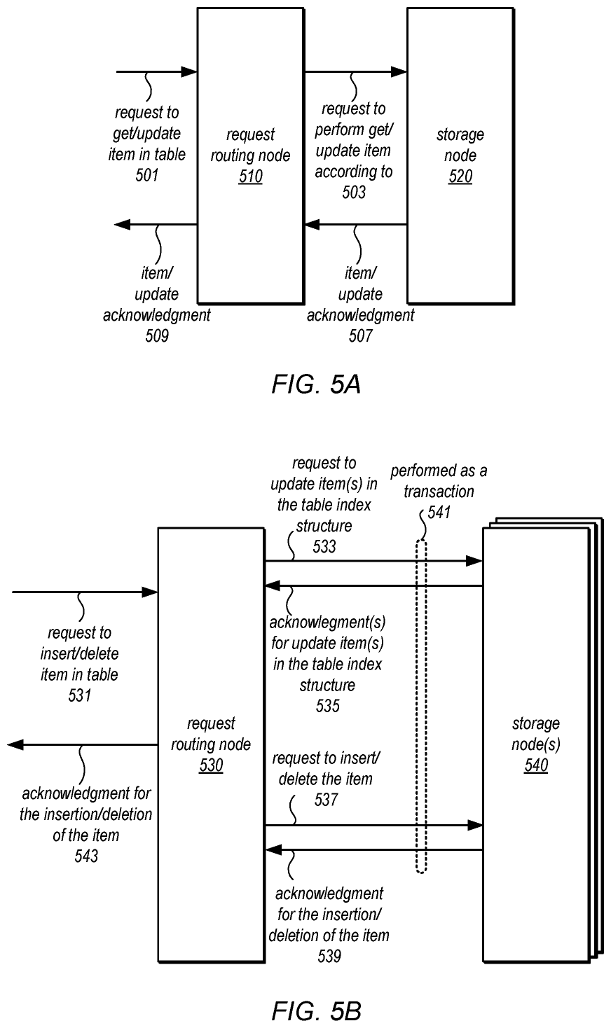

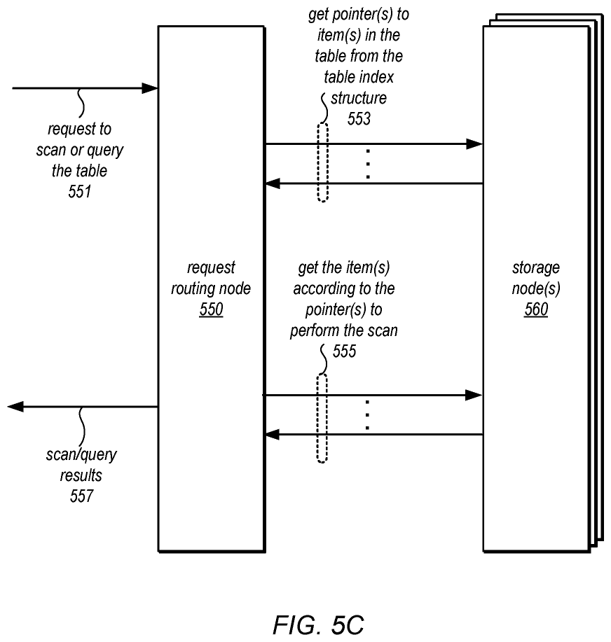

In at least some embodiments, an index structure may also be stored in key-value database as items to be partitioned. For example, table A index structure includes items 132d, 142f, 152d, and 152f stored in different partitions, table B index structure includes items 122d, 122e, 132e, 142e, and 152e, and table C index structure includes items 122f, 132f, and 142d, each of which is assigned to a multi-table partition according to multi-table partitioning scheme 104, in some embodiments. As discussed in detail below with regard to FIGS. 5B, 5C, and 7, some access requests 102 may include updates to table index structures in addition to requests performed with respect to items identified in the requests, in some embodiments.

Please note that previous descriptions of implementing multi-table partitions in a key-value database are not intended to be limiting, but are merely provided as logical examples. For example, the number, size, type, and arrangement of partitions, tables, or index structures may be different than those discussed above with regard to FIG. 1

This specification begins with a general description of a provider network that may implement a database service that may implement multi-table partitions in a key-value database. Then various examples of a database service are discussed, including different components/modules, or arrangements of components/module, that may be employed as part of implementing the database service, in one embodiment. A number of different methods and techniques to implement multi-table partitions in a key-value database are then discussed, some of which are illustrated in accompanying flowcharts.

Finally, a description of an example computing system upon which the various components, modules, systems, devices, and/or nodes may be implemented is provided. Various examples are provided throughout the specification.

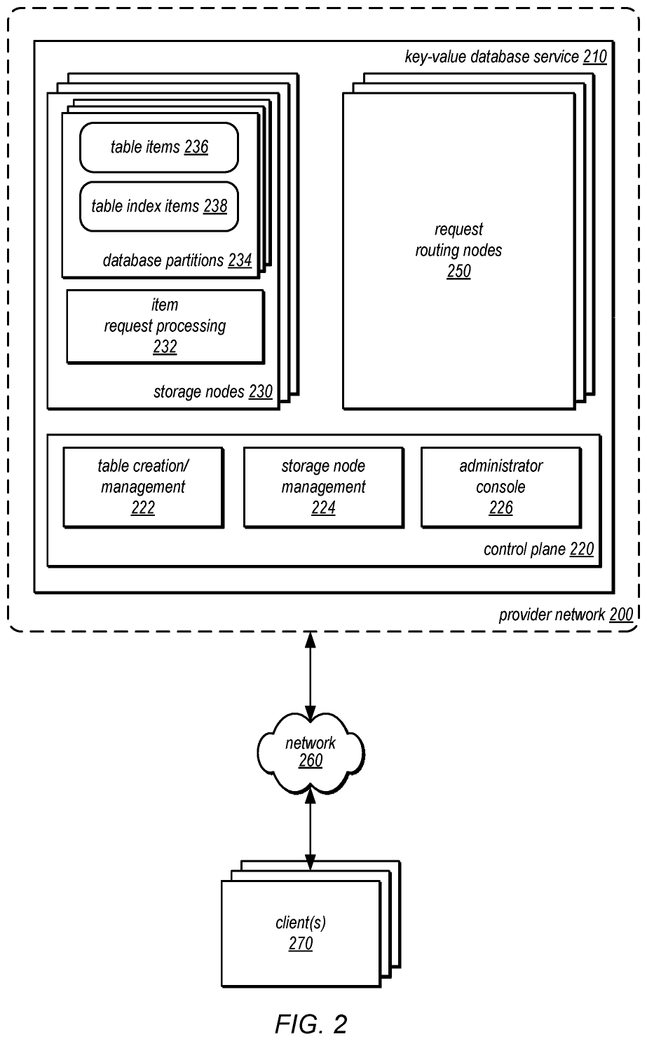

FIG. 2 is a logical block diagram illustrating a provider network offering a database service that may implement multi-table partitions in a key-value database, according to some embodiments. Provider network 200 may be a private or closed system, in one embodiment, or may be set up by an entity such as a company or a public sector organization to provide one or more services (such as various types of cloud-based storage) accessible via the Internet and/or other networks to clients 250, in another embodiment. In one embodiment, provider network 200 may be implemented in a single location or may include numerous data centers hosting various resource pools, such as collections of physical and/or virtualized computer servers, storage devices, networking equipment and the like (e.g., computing system 1000 described below with regard to FIG. 9), needed to implement and distribute the infrastructure and storage services offered by the provider network 200. In one embodiment, provider network 200 may implement various computing resources or services, such as key-value database service 210 (e.g., a non-relational (NoSQL) database or other key-value database service), and other services (not illustrated), such as a data warehouse service, data flow processing service, and/or other large scale data processing techniques), data storage services (e.g., an object storage service, block-based storage service, or data storage service that may store different types of data for centralized access), virtual compute services, and/or any other type of network-based services (which may include various other types of storage, processing, analysis, communication, event handling, visualization, and security services).

In various embodiments, the components illustrated in FIG. 2 may be implemented directly within computer hardware, as instructions directly or indirectly executable by computer hardware (e.g., a microprocessor or computer system), or using a combination of these techniques. For example, the components of FIG. 2 may be implemented by a system that includes a number of computing nodes (or simply, nodes), in one embodiment, each of which may be similar to the computer system embodiment illustrated in FIG. 9 and described below. In one embodiment, the functionality of a given system or service component (e.g., a component of key value database service 210) may be implemented by a particular node or may be distributed across several nodes. In some embodiments, a given node may implement the functionality of more than one service system component (e.g., more than one data store component).

Key-value database service 210 may be implemented various types of distributed database services, in one embodiment, for storing, accessing, and updating data in tables hosted in key-value database. Such services may be enterprise-class database systems that are highly scalable and extensible. In one embodiment, access requests (e.g., requests to get/obtain items, put/insert items, delete items, update or modify items, scan multiple items) may be directed to a table in key-value database service 210 that is distributed across multiple physical resources according to a partitioning scheme, such as the partitioning schemes discussed above with regard to FIG. 1, and the database system may be scaled up or down on an as needed basis. In one embodiment, clients/subscribers may submit requests in a number of ways, e.g., interactively via graphical user interface (e.g., a console) or a programmatic interface to the database system. In one embodiment, key-value database service 210 may provide a RESTful programmatic interface in order to submit access requests (e.g., to get, insert, delete, or scan data).

In one embodiment, clients 250 may encompass any type of client configurable to submit network-based requests to provider network 200 via network 260, including requests for key-value database service 210 (e.g., to access item(s) in a table in key-value database service 210). For example, in one embodiment a given client 250 may include a suitable version of a web browser, or may include a plug-in module or other type of code module that executes as an extension to or within an execution environment provided by a web browser. Alternatively in a different embodiment, a client 250 may encompass an application such as a database client/application (or user interface thereof), a media application, an office application or any other application that may make use of a database in key-value database service 210 to store and/or access the data to implement various applications. In one embodiment, such an application may include sufficient protocol support (e.g., for a suitable version of Hypertext Transfer Protocol (HTTP)) for generating and processing network-based services requests without necessarily implementing full browser support for all types of network-based data. That is, client 250 may be an application that interacts directly with provider network 200, in one embodiment. In one embodiment, client 250 may generate network-based services requests according to a Representational State Transfer (REST)-style network-based services architecture, a document- or message-based network-based services architecture, or another suitable network-based services architecture. Note that in some embodiments, clients of key-value database service 210 may be implemented within provider network 200 (e.g., applications hosted on a virtual compute service).

In some embodiments, clients of key-value database service 210 may be implemented on resources within provider network 200 (not illustrated). For example, a client application may be hosted on a virtual machine or other computing resources implemented as part of another provider network service that may send access requests to key-value database service 210 via an internal network (not illustrated).

In one embodiment, a client 250 may provide access to provider network 200 to other applications in a manner that is transparent to those applications. For example, client 250 may integrate with a database on key-value database service 210. In such an embodiment, applications may not need to be modified to make use of a service model that utilizes key-value database service 210. Instead, the details of interfacing to the key-value database service 210 may be coordinated by client 250.

Client(s) 250 may convey network-based services requests to and receive responses from provider network 200 via network 260, in one embodiment. In one embodiment, network 260 may encompass any suitable combination of networking hardware and protocols necessary to establish network-based-based communications between clients 250 and provider network 200. For example, network 260 may encompass the various telecommunications networks and service providers that collectively implement the Internet. In one embodiment, network 260 may also include private networks such as local area networks (LANs) or wide area networks (WANs) as well as public or private wireless networks. For example, both a given client 250 and provider network 200 may be respectively provisioned within enterprises having their own internal networks. In such an embodiment, network 260 may include the hardware (e.g., modems, routers, switches, load balancers, proxy servers, etc.) and software (e.g., protocol stacks, accounting software, firewall/security software, etc.) necessary to establish a networking link between given client(s) 250 and the Internet as well as between the Internet and provider network 200. It is noted that in one embodiment, client(s) 250 may communicate with provider network 200 using a private network rather than the public Internet.

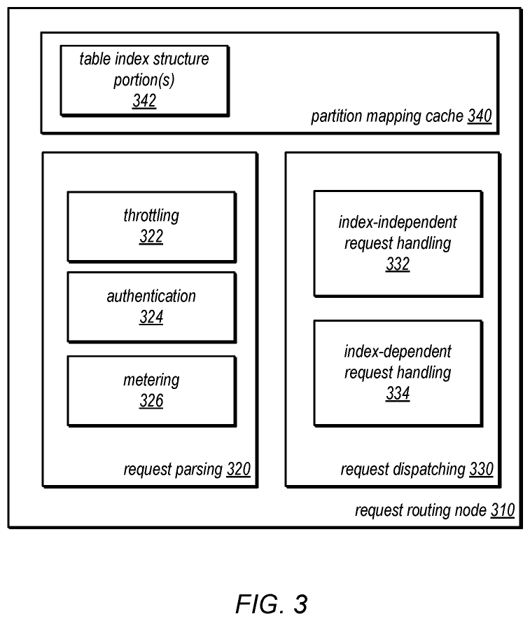

Key-value database service 210 may implement request routing nodes 250, in one embodiment. Request routing nodes 250 may receive and parse access requests, in various embodiments in order to determine various features of the request, to parse, authenticate, throttle and/or dispatch access requests, among other things, in one embodiment. FIG. 3 is a logical block diagram illustrating a request router for that routes access requests to storage nodes storing a data as part of a key-value database with multi-table partitions, according to some embodiments.

In one embodiment, request routing nodes, such as request routing node 310 in FIG. 3, may support handling requests formatted according to an interface to support different types of web services requests. For example, in one embodiments, key-value database service 210 may implement a particular web services application programming interface (API) that supports a variety of operations on tables (or other data objects) that are maintained and managed on behalf of clients/users by the data storage service system (and/or data stored in those tables). In one embodiment, key-value database service 210 may support different types of services requests. For example, in one embodiments, key-value database service 210 may implement a particular web services application programming interface (API) that supports a variety of operations on tables (or other data objects) that are maintained and managed on behalf of clients/users by the data storage service system (and/or data stored in those tables), such as a request to perform a scan or batch operation on multiple items in one or more tables. Similarly, a request may be a request to perform operations on individual items (e.g., requests to read or get, write, update, modify, delete, add, or insert items in a table, according to a specified consistency level or characteristic), in some embodiments. Request routing node 310 may implement request parsing 320 to identify, extract, or otherwise determine different features of requests according to the format in which the requests were submitted for further processing.

In one embodiment, request routing node 310 may perform throttling of access requests according to a service limit (e.g., specified by key-value database service 210 and/or according to a user specified parameter or control, such as a purchased or provisioned performance level or capacity), whereas in other embodiments no throttling may be implemented. As illustrated in FIG. 3, request parsing 320 may also perform various operations to validate (e.g., the operation, data, item, table, etc.) in the access request and/or authenticate 324 the right of the client application (e.g., according to a user credential or other identifier) to perform the access request. In some embodiments, request parsing may implement metering 326 for requests (e.g., identifying how much data is accessed, how often the data is accessed, which data is accessed, among other performance or usage metrics) that may be used to determine a cost of using key-value database service 210 for an individual client application, user or other account.

In one embodiment, request routing node 310 may implement request dispatching 330. Request dispatching 330 may handle requests to access items in a table in key-value database service 210 according to a partitioning scheme that partitions a table into multi-table partitions where one or more items (e.g., at least one item) from multiple different tables (e.g., two or more tables) may be included in a same partition, in some embodiments. Request dispatching may perform encryption and/or decryption of items stored in or retrieved from multi-table partitions, in some embodiments, so that access requests for different tables stored in a same partition can only encrypt or decrypt items from one table for a user authorized to access that table. Some access requests may be able to access the desired item by applying the partitioning scheme to identify the appropriate partition, and dispatching the request to the identified partition. For example, index-independent request handling 332 may not require updates, modifications, or access to a table index structure in order to perform the request, as discussed below with regard to FIGS. 5A and 7. Instead, requests to access the item may be performed without being dependent upon the index structure. In alternative embodiments of multi-table partitions for key-value data stores that do not, for instance, support scans or requests to look at an entire, for example (or may support such requests without guaranteeing a consistent table state), table index structure may not be implemented in order to provide access to items in a table stored in multi-table partitions.

In at least some embodiments, index-dependent request handling 334 may be implemented as part of request dispatching 330 in some embodiments. Index-dependent request handling 334 may dispatch one or multiple requests to perform a received access request that may dependent upon information obtained from, removed from, updated in, or added to a table index structure, such as table index structure 400 discussed below with regard to FIG. 4A, in some embodiment. For example, FIGS. 5B, 5C, 7, and 8 describe various scenarios where a table index structure may be used to identify the contents or items in a table as table items may be distributed across multiple partitions that also store items of another table so that merely identifying a partition for a table may not be enough to distinguish the items in the partition that belong to a particular table, in some embodiments. Index-dependent request handling 334 may identify, execute, direct, or otherwise cause operations to access the table index structure in order to perform various requests (e.g., by sending requests to the appropriate storage node that stores an item that is part of a table index structure), in some embodiments. In some embodiments, index-dependent request handling 334 may support various different transaction protocols or request processing methods to perform as a single transaction both update(s) to a table index structure and update(s) to item(s) for index-dependent access requests, as discussed below with regard to FIG. 5B.

Both index-independent request handling 332 and index-dependent request handling 334 may be able to apply the partitioning scheme for multi-table partitioning in the key-value database service 210 in order to identify a given partition for an item in any of the tables hosted in key-value database service 210. Partition mapping cache 340 may be implemented by request routing node 310 in order to cache the partitions mapped to various items, in some embodiments. In this way, request dispatching 330 can rely upon cached partition mappings for items to increase the speed at which requests can be dispatched, in some embodiments.

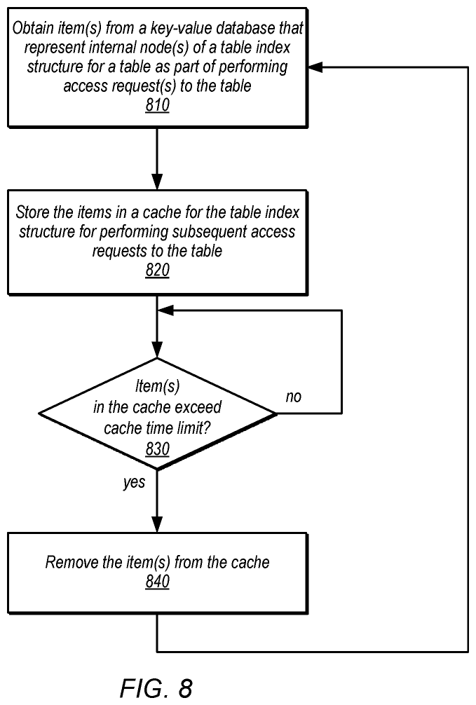

Index-dependent request handling 334 may further utilize cached items or other portions of table index structures 342, in some embodiments. For instance, as illustrated in FIG. 5B and 5C, some interactions to access item(s) according to a received access request may use a table index structure as discussed below with regard to FIGS. 4A and 4B in order to identify what and/or where items in a table are located to perform the access request, in some embodiments. Because evaluation of the table index structure could involve multiple requests for items in the index structure (e.g., multiple requests to access different tree nodes in order to traverse the tree to identify items that belong to an identified table), some request processing time or other costs (e.g., network bandwidth, processing capacity) by caching portions of a table index structure for a table at a request routing node, in some embodiments. For example, a root node and one or more internal nodes of the table index structure could be cached, whereas the leaf nodes may not be cached, in some embodiments. FIG. 8, discussed below, provides examples of techniques that may be implemented by request dispatching 330, for example, to manage the content of table index structure portion 342 maintained in partition mapping cache 340, in some embodiments.

In one embodiment, key-value database service 210 may implement control plane 220 to implement one or more administrative components, such as automated admin instances which may provide a variety of visibility and/or control functions). In various embodiments, control plane 320 may direct the performance of different types of control plane operations among the nodes, systems, or devices implementing key-value database service 210, in one embodiment. Control plane 220 may provide visibility and control to system administrators via administrator console 226, in some embodiment. Admin console 226 may allow system administrators to interact directly with key-value database service 210 (and/or the underlying system). In one embodiment, the admin console 226 may be the primary point of visibility and control for key-value database service 210 (e.g., for configuration or reconfiguration by system administrators). For example, the admin console may be implemented as a relatively thin client that provides display and control functionally to system administrators and/or other privileged users, and through which system status indicators, metadata, and/or operating parameters may be observed and/or updated. Control plane 220 may provide an interface or access to information stored about one or more detected control plane events, such as data backup or other management operations for a table, at key-value database service 210, in one embodiment.

Storage node management 224 may provide resource allocation, in one embodiment, for storing additional data in table submitted to database key-value service 210. For instance, control plane 220 may communicate with processing nodes to initiate the performance of various control plane operations, such as moves of multi-table partitions, splits of multi-table partitions, update tables, delete tables, create indexes, etc. . . . In one embodiment, control plane 220 may include a node recovery feature or component that handles failure events for storage nodes 230, and request routing nodes 250 (e.g., adding new nodes, removing failing or underperforming nodes, deactivating or decommissioning underutilized nodes, etc).

Various durability, resiliency, control, or other operations may be directed by control plane 220. For example, storage node management 224 may detect split, copy, or move events for multi-table partitions at storage nodes in order to ensure that the storage nodes maintain satisfy a minimum performance level for performing access requests. For instance, in various embodiments, there may be situations in which a partition (or a replica thereof) may need to be copied, e.g., from one storage node to another. For example, if there are three replicas of a particular partition, each hosted on a different physical or logical machine, and one of the machines fails, the replica hosted on that machine may need to be replaced by a new copy of the partition on another machine. In another example, if a particular machine that hosts multiple partitions of one or more tables experiences heavy traffic, one of the heavily accessed partitions may be moved (using a copy operation) to a machine that is experiencing less traffic in an attempt to more evenly distribute the system workload and improve performance. In some embodiments, storage node management 224 may perform partition moves using a physical copying mechanism (e.g., a physical file system mechanism, such as a file copy mechanism) that copies an entire partition from one machine to another, rather than copying a snapshot of the partition data row by. While the partition is being copied, write operations targeting the partition may be logged. During the copy operation, any logged write operations may be applied to the partition by a catch-up process at periodic intervals (e.g., at a series of checkpoints). Once the entire partition has been copied to the destination machine, any remaining logged write operations (i.e. any write operations performed since the last checkpoint) may be performed on the destination partition by a final catch-up process. Therefore, the data in the destination partition may be consistent following the completion of the partition move, in some embodiments. In this way, storage node management 224 can move partitions amongst storage nodes 230 while the partitions being moved are still “live” and able to accept access requests.

In some embodiments, the partition moving process described above may be employed in partition splitting operations by storage node management 224 in response to the detection of a partition split event. For example, a partition may be split because it is large, e.g., when it becomes too big to fit on one machine or storage device and/or in order to keep the partition size small enough to quickly rebuild the partitions hosted on a single machine (using a large number of parallel processes) in the event of a machine failure. A partition may also be split when it becomes too “hot” (i.e. when it experiences a much greater than average amount of traffic as compared to other partitions). For example, if the workload changes suddenly and/or dramatically for a given partition, the system may be configured to react quickly to the change. In some embodiments, the partition splitting process described herein may be transparent to applications and clients/users, which may allow the data storage service to be scaled automatically (i.e. without requiring client/user intervention or initiation).

In some embodiments, each database partition 234 may be identified by a partition ID, which may be a unique number (e.g., a GUID) assigned at the time the partition is created. A partition 234 may also have a version number that is incremented each time the partition goes through a reconfiguration (e.g., in response to adding or removing replicas, but not necessarily in response to a master failover). When a partition is split, two new partitions may be created, each of which may have a respective new partition ID, and the original partition ID may no longer be used, in some embodiments. In some embodiments, a partition may be split by the system using a split tool or process in response to changing conditions.

Split or move events may be detected by storage node management 224 in various ways. For example, partition size and heat, where heat may be tracked by internally measured metrics (such as IOPS), externally measured metrics (such as latency), and/or other factors may be evaluated with respect to various performance thresholds.

System anomalies may also trigger split or move events (e.g., network partitions that disrupt communications between replicas of a partition in a replica group, in some embodiments. Storage node management 224 may detect storage node failures, or provide other anomaly control, in some embodiments. If the partition replica hosted on the storage node on which a fault or failure was detected was the master for its replica group, a new master may be elected for the replica group (e.g., from amongst remaining storage nodes in the replica group). Storage node management 224 may initiate creation of a replacement partition replica while the source partition replica is live (i.e. while one or more of the replicas of the partition continue to accept and service requests directed to the partition), in some embodiments. In various embodiments, the partition replica on the faulty storage node may be used as the source partition replica, or another replica for same partition (on a working machine) may be used as the source partition replica, e.g., depending type and/or severity of the detected fault.

Control plane 220 may implement table creation and management 222 to manage the creation (or deletion) of database tables hosed in key-value database service 210, in some embodiments. For example, a request to create a table may be submitted via administrator console 226 which may initiate performance of a workflow to generate appropriate system metadata (e.g., a table identifier that is unique with respect to all other tables in key-value database service 210, table performance or configuration parameters, etc.). Because tables may be stored in multi-table partitions, resource allocation for a table to be created may be avoided as multi-partition tables may be updated to handle additional data according to storage node management 224 or other partition management features, in some embodiments.

In one embodiment, key-value database service 210 may also implement a plurality of storage nodes 230, each of which may manage one or more partitions of a database table on behalf of clients/users or on behalf of key-value database service 210 which may be stored in database storage 234 (on storage devices attached to storage nodes 230 or in network storage accessible to storage nodes 230).

Storage nodes 230 may implement item request processing 232, in one embodiment. Item request processing 232 may perform various operations (e.g., read/get, write/update/modify/change, insert/add, or delete/remove) to access individual items stored in tables in key-value database service 210, in one embodiment. In some embodiments, item request processing 232 may support operations performed as part of a transaction, including techniques such as locking items in a transaction and/or ordering requests to operate on an item as part of transaction along with other requests according to timestamps (e.g., timestamp ordering) so that storage nodes 230 can accept or reject the transaction-related requests. In some embodiments, item request processing 232 may maintain database partitions 234 according to a database model (e.g., a non-relational, NoSQL, or other key-value database model).

In one embodiment, key-value database service 210 may provide functionality for creating, accessing, and/or managing tables or secondary indexes at nodes within a multi-tenant environment. For example, database partitions 234 may store table item(s) 236 from multiple tables, indexes, or other data stored on behalf of different clients, applications, users, accounts or non-related entities, in some embodiments. Thus database partitions 234 may be multi-tenant, in some embodiments when storing items from different database tables.

In addition to dividing or otherwise distributing data (e.g., database tables) across storage nodes 230 in separate partitions, storage nodes 230 may also be used in multiple different arrangements for providing resiliency and/or durability of data as part of larger collections or groups of resources. A replica group, for example, may be composed of a number of storage nodes maintaining a replica of particular portion of data (e.g., a partition) for the key-value database service 210. Moreover, different replica groups may utilize overlapping nodes, where a storage node 330 may be a member of multiple replica groups, maintaining replicas for each of those groups whose other storage node 330 members differ from the other replica groups.

Different models, schemas or formats for storing data for database tables in key-value database service 210 may be implemented, in some embodiments. For example, in some embodiments, non-relational, NoSQL, semi-structured, or other key-value data formats may be implemented. In at least some embodiments, the data model may include tables containing items 236 that have one or more attributes. In such embodiments, each table maintained on behalf of a client/user may include one or more items, and each item may include a collection of one or more attributes. The attributes of an item may be a collection of one or more name-value pairs, in any order, in some embodiments. In some embodiments, each attribute in an item may have a name, a type, and a value. In some embodiments, the items may be managed by assigning each item a primary key value (which may include one or more attribute values), and this primary key value may also be used to uniquely identify the item. In some embodiments, a large number of attributes may be defined across the items in a table, but each item may contain a sparse set of these attributes (with the particular attributes specified for one item being unrelated to the attributes of another item in the same table), and all of the attributes may be optional except for the primary key attribute(s). In other words, the tables maintained by the key-value database service 210 (and the underlying storage system) may have no pre-defined schema other than their reliance on the primary key.

Metadata or other system data for tables may also be stored as part of database partitions using the same partitioning scheme, in some embodiments. For example, table index items 238 may be stored in a same fashion as table items.

Key-value database service 210 may provide an application programming interface (API) for requesting various operations targeting tables, indexes, items, and/or attributes maintained on behalf of storage service clients. In some embodiments, the service (and/or the underlying system) may provide both control plane APIs and data plane APIs. The control plane APIs provided by key-value database service 210 (and/or the underlying system) may be used to manipulate table-level entities, such as tables and indexes and/or to re-configure various tables These APIs may be called relatively infrequently (when compared to data plane APIs). In some embodiments, the control plane APIs provided by the service may be used to create tables or secondary indexes for tables at separate storage nodes, import tables, export tables, delete tables or secondary indexes, explore tables or secondary indexes (e.g., to generate various performance reports or skew reports), modify table configurations or operating parameter for tables or secondary indexes, and/or describe tables or secondary indexes. In some embodiments, control plane APIs that perform updates to table-level entries may invoke asynchronous workflows to perform a requested operation. Methods that request “description” information (e.g., via a describeTables API) may simply return the current known state of the tables or secondary indexes maintained by the service on behalf of a client/user. The data plane APIs provided by key-value database service 210 (and/or the underlying system) may be used to perform item-level operations, such as requests for individual items or for multiple items in one or more tables table, such as queries, batch operations, and/or scans.

The APIs provided by the service described herein may support request and response parameters encoded in one or more industry-standard or proprietary data exchange formats, in different embodiments. For example, in various embodiments, requests and responses may adhere to a human-readable (e.g., text-based) data interchange standard, (e.g., JavaScript Object Notation, or JSON), or may be represented using a binary encoding (which, in some cases, may be more compact than a text-based representation). In various embodiments, the system may supply default values (e.g., system-wide, user-specific, or account-specific default values) for one or more of the input parameters of the APIs described herein.

Key-value database service 210 may include support for some or all of the following operations on data maintained in a table (or index) by the service on behalf of a storage service client: perform a transaction (inclusive of one or more operations on one or more items in one or more tables), put (or store) an item, get (or retrieve) one or more items having a specified primary key, delete an item, update the attributes in a single item, query for items using an index, and scan (e.g., list items) over the whole table, optionally filtering the items returned, or conditional variations on the operations described above that are atomically performed (e.g., conditional put, conditional get, conditional delete, conditional update, etc.). For example, the key-value database service 210 (and/or underlying system) described herein may provide various data plane APIs for performing item-level operations, such as a TransactItems API, PutItem API, a GetItem (or GetItems) API, a DeleteItem API, and/or an UpdateItem API, as well as one or more index-based seek/traversal operations across multiple items in a table, such as a Query API and/or a Scan API.

Different indexing structures for tables may be implemented in various embodiments, such as n-ary tree based structures (e.g., B tree, B+ tree, etc), in some embodiments. The indexing structures may be maintained as part of the key-value database as table items, in some embodiments (e.g., as part of the same table that is indexed by the structure or a separate table). FIG. 4A is an example table of one such index structure for a table stored in multi-table partitions in a key-value database, according to some embodiments.

Table index structure 400 may be implemented as different nodes in a tree, such as index node 410, root node 420, internal nodes 430 and 440, and leaf nodes, such as leaf nodes 450 and 460. Each node may be stored as an item in key-value database service 210, which may be partitioned according to a same partitioning scheme (e.g., by applying a hash function to an item identifier and table identifier). When a node is created in table index structure 400, a Globally Unique Identifier (GUID) may be create so that there are no collisions among the items in the index structure and other items in key-value database service 210, in some embodiments.

Index node 410 may be implemented as part of table index structure 400 in some embodiments. Index node 410 may be a fixed or statically defined root to the other nodes of the index structure, in some embodiments. For example, index node 410 may be identified according to GUID 412 (in order to perform a get or other request to obtain the index node) and a pointer 414 to whatever node is the root node of table index structure, such as root node 420 because root node 420 could change if, for instance a rebalancing operation were to be performed for the b+ tree structure illustrated in FIG. 4B. In this way, if another node were to be promoted, moved, or created to be root node 420, the index node pointer 414 can be updated according to provide access to the new root node.

Root node 420 and internal nodes, such as internal node 430 and internal node 440 may, for instance, utilize a b tree based structure. An attribute of each node may include a GUID for performing a request to access or update the node, such as GUIDs 422, 432, and 442, respectively. In the illustrated table index structure, hash value ranges, such as hash value ranges 424a, 424b, 434a, 434b, 444a, and 444b may be attributes (although in other embodiments, a primary key value or other value for indexing the table may be used) along with respective pointers to the child node that corresponds to the hash range value, such as pointers 426a, 426b, 436a, 436b, 446a, and 446b.

As depicted in FIG. 4A, table index structure represents a b+ tree, where leaf nodes, such as leaf nodes 450 and 460 store values separately from the leaf node (although other formats, such as b tree formats that do include item values in the leaf node could be implemented, in other embodiments). The primary key of the item, such as primary key 454a of item 472, may be stored (and as depicted by primary keys 454b, 464a, and 464b. In some embodiments, leaf nodes may incorporate pointers to provide or implement a doubly linked list between leaf nodes, such as previous pointers 457 and 467 and next pointers 458 and 468, in some embodiments.

In some embodiments, secondary indexes may be supported to provide a different structure for organizing or searching a table different than a primary table index (e.g., as illustrated above in FIG. 4A). Secondary indexes, for example, may be created for a table in order to provide an alternative access schema for items in addition to the schema implemented by the data store, in some embodiments. Consider an example of a table that includes items for registered users and may include a user identifier, which is unique and primary key for the item, along with a first name attribute, last name attribute, gender attribute, and age attribute. A secondary index may be generated for the table which can index items according to other values than the key value pair, such as gender and age. For example, the secondary index may be generated so that all items with male attribute values are stored together according to age attribute value order. Similarly, all items with female attribute values are stored together according to age attribute value order. In this way, an access request for data that specifies a particular range of ages for males or females may be quickly obtained without performing a scan of the entire table of items, as noted above. Other attribute values may also be included in the secondary index, such as first and last name attribute values, in some embodiments. In various embodiments, the secondary index may include a pointer to those items in the distributed data set, such as the key value that uniquely identifies the item, hash value (or other multi-table partitioning scheme value).

Once created, a secondary index can be maintained to reflect changes made to the table, in some embodiments. Changes can be reflected in the secondary index to be eventually consistent, guaranteeing that changes committed to the distributed data set will eventually be reflected in the secondary index, or strongly-consistent, guaranteeing that changes to the distributed data set will be consistent with the secondary index once the changes are committed to the secondary index, in some embodiments.

FIG. 4B is a secondary index structure stored in multi-table partitions in a key-value database, according to some embodiments. Secondary index structure 401 may be implemented as different nodes in a tree, similar to table index structure 400 in FIG. 4A, with index node 411, root node 421, internal nodes 431 and 441, and leaf nodes, such as leaf nodes 451 and 461. Each node may be stored as an item in key-value database service 210, which may be partitioned according to a same partitioning scheme (e.g., by applying a hash function to an item identifier and table identifier). When a node is created in secondary index structure 401, a Globally Unique Identifier (GUID) may be created so that there are no collisions among the items in the index structure and other items in key-value database service 210, in some embodiments.

Index node 411 may be implemented as part of secondary index structure 401 in some embodiments. Index node 411 may be a fixed or statically defined root to the other nodes of the index structure, in some embodiments. For example, index node 411 may be identified according to GUID 413 (in order to perform a get or other request to obtain the index node) and a pointer 415 to whatever node is the root node of table index structure, such as root node 421 because root node 421 could change if, for instance a rebalancing operation were to be performed for the b+ tree structure illustrated in FIG. 4B. In this way, if another node were to be promoted, moved, or created to be root node 421, the index node pointer 415 can be updated according to provide access to the new root node.

Root node 421 and internal nodes, such as internal node 431 and internal node 441 may, for instance, utilize a b tree based structure, like a b+ tree. An attribute of each node may include a GUID for performing a request to access or update the node, such as

GUIDs 423, 433, and 443, respectively. In the illustrated secondary index structure, key value ranges, such as index key ranges 425a, 425b, 435a, 435b, 445a, and 445b may be the selected attribute (which may different than the primary key value for a table that is the source of items in the secondary index) along with respective pointers to the child node that corresponds to the index key range, such as pointers 427a, 427b, 437a, 437b, 447a, and 447b.

As depicted in FIG. 4B, a secondary index structure may be structured as a b+ tree, where leaf nodes, such as leaf nodes 451 and 461 store pointers to values separately from the leaf node (although other formats, such as b tree formats that do include item values in the leaf node could be implemented, in other embodiments). The index key value of an item, such as index key value 455a of item 473, may be stored along with a pointer to an item in the leaf node, such as pointer 481a to item 473, (and as depicted by index key values 455b, 465a, and 465b, and pointers 481b, 483a, and 483b). In some embodiments, pointers to items may be the hash value that can identify the multi-table partition for the item (or both the table identifier and item identifier to generate the hash value or other values used to apply the partitioning scheme). In some embodiments, leaf nodes may incorporate pointers to provide or implement a doubly linked list between leaf nodes, such as previous pointers 456 and 466 and next pointers 459 and 469, in some embodiments.

Different requests to access items stored in multi-table partitions may be handled differently, in some embodiments. For example, in FIG. 5A a request 501 to get (e.g., obtain or read) or update (e.g., modify, change, or alter) an existing item in table may be received at request router 510 (which may be similar to request routers 310 and 250 in FIGS. 2 and 3 discussed respectively above). Request routing node 510 may recognize the request 501 to get or update an item in a table as a request that does not dependent upon an index structure for the table to be performed. As illustrated in FIG. 5A, request routing node 510 may dispatch the request to the storage node 520 that is identified as storing the multi-table partition that includes the item to get or update according to the partitioning scheme for key-value database 210 (e.g., by hashing a combination of the item's key value and table's value into a hash value that is mapped to a multi-table partition stored at storage node 520). Storage node 520 may then perform the request and return the item or acknowledge the update 507 to request routing node 510 which may in turn provide the item or update acknowledgement 509 back to a requesting client application, in some embodiments.

In FIG. 5B, an example request to insert or delete an item in a table 531 may be received at request routing node 530 (which may be similar to request routers 310 and 250 in FIGS. 2 and 3 discussed respectively above). Request routing node 530 may recognize request 531 as a request that is dependent on a table index structure for the table identified in request 531. Request routing node 530 may evaluate or determine update(s) to item(s) in the table index structure. For example, request routing node 530 may traverse the table index structure by submitting requests for the index node, root node, one or more internal nodes and one or more leaf nodes, in various embodiments, to determine what item(s) in the table index structure may need to be updated. If, for instance, a request or delete of an item may involve adding or removing an attribute of a leaf node that points to the item in the table, in some embodiments. In some embodiments, updates to the table index structure may include changes made to other nodes (e.g., adjusting hash range values), promoting or adding nodes to the index structure, and so on, so that corresponding changes to items (e.g., by creating and storing new items, or adding, changing, removing item attributes) may be also need to be performed. As discussed above with regard to FIG. 3, a cache of at least a portion of a table index structure may be used to reduce the number of requests to evaluate the table index structure in some embodiments.

As indicated at 533, one or more requests may be dispatched by request routing node 530 to perform the update(s) to item(s) in the table index structure. Acknowledgement(s) 535 for update item(s) in the table index structure may be received, in some embodiments. A request to insert or delete the item 537 may be sent to the appropriately identified storage node 540 that stores the multi-table partition that stores the item, in various embodiments. Storage node(s) 540 may perform the insertion or deletion (or add a tombstone or other marker at the item or in table metadata to ignore and present the item as deleted even if the item is not yet physically removed from storage). An acknowledgement for the insertion or deletion of the item may be received, as indicated at 539, at request routing node 530. The update(s) to the table index structure 533 and the request to insert or delete the item 537 may, in at least some embodiments, be performed as a transaction 541. In this way, changes to the table index structure may not be made if, for instance, the request to insert or delete the item fails (e.g., because of an intervening request or storage node failure, in some embodiments. A lock-based transaction protocol may, for instance, be implemented in some embodiments so that the transaction 541 may not be performed until a lock is obtained on the affected items, in some embodiments. Alternatively, a lock-free transaction protocol (e.g., based on information exchanged between storage nodes 540 and/or between request routing node 530) may be implemented in some embodiments. If the transaction does not complete entirely successfully, then the request to insert or delete the item may fail (not illustrated), and a failure indication may be sent in response (not illustrated). However, as indicated at 543 an acknowledgment of the insertion or deletion 543 may be sent if transaction 541 is successful, in some embodiments.

In FIG. 5C, an example request to scan or query a table 551 may be received at request routing node 550 (which may be similar to request routers 310 and 250 in FIGS. 2 and 3 discussed respectively above). Request routing node 550 may recognize request 551 as a request that is dependent on a table index structure for the table identified in request 551. Request routing node 530 may evaluate the table index structure to get pointer(s) to item(s) in the table from the table index structure, as indicated at 553. For example, request routing node 550 may traverse the table index structure by submitting multiples requests for the index node, root node, one or more internal nodes, and one or more leaf nodes, in various embodiments, to determine what item(s) in the exist and/or need to be evaluated to perform the scan or query. In some embodiments, leaf nodes of the table index structure may be implemented with a doubly linked list allowing the request routing node to traverse the leaf nodes in the table index structure to perform the scan or query. As discussed above with regard to FIG. 3, a cache of at least a portion of a table index structure may be used to reduce the number of requests to evaluate the table index structure in some embodiments.

As indicated at 555, the item(s) may be gotten, obtained, or otherwise retrieved 555 from storage node(s) according to the pointer(s) obtained for the items from the appropriately identified storage node(s) 560 that store multi-table partitions that include the items identified by the pointer(s) (e.g., by hashing the pointer value as the GUID for the item and an identifier for the table in order to use a hash value generated from the two values to identify a multi-table partition and corresponding storage node 560). Request routing node 550 may return the scan/query results 557 as they are received. In some embodiments, a consistency level may be specified for the scan or query (e.g., eventually consistent or strongly consistent) which may affect the success or failure of the request if view of the table is not available at the specified consistency level.

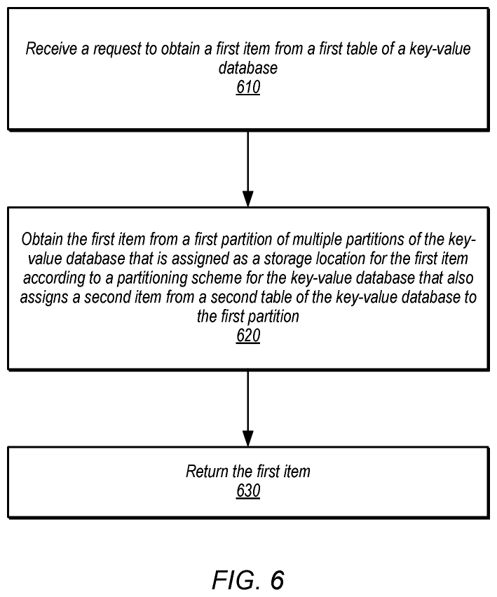

The examples of a database service that implements as discussed in FIGS. 2-5C above have been given in regard to a database service (e.g., a non-relational, NoSQL, or other key-value database service). However, various other types of distributed data storage systems that utilize a key-value access paradigm may implement multi-table partitions in a key-value database, in other embodiments. FIG. 6 is a high-level flowchart illustrating various methods and techniques to implement multi-table partitions in a key-value database, according to some embodiments. These techniques, as well as the techniques discussed with regard to FIGS. 7-8, may be implemented using components or systems as described above with regard to FIGS. 2-5C, as well as other types of databases, storage engines, or distributed storage systems, and thus the following discussion is not intended to be limiting as to the other types of systems that may implement the described techniques.

As indicated at 610, a request to obtain a first item from a first table of a key-value database may be received, in some embodiments. For example, a request may be formatted according to a programmatic interface, such as an API request to get, read, or otherwise retrieve an item specified in the request. In some embodiments, the item may be specified according to a key value (e.g., a primary key value that uniquely identifies an item). In some embodiments, the request may specify a table that stores the item. The table may be identified by a name, which may or may not be a unique identifier. If the table name is not a unique identifier, however, a unique identifier for the table may be mapped to the name (e.g., by mapping the table name for a particular, client application, or account to a unique table identifier name), in at least some embodiments.

As indicated at 620, the first item may be obtained from a first partition of multiple partitions of the key-value database that is assigned as a storage location for the first item according to a partitioning scheme for the key-value database that also assigns a second item from a second table of the key-value database to the first partition, according to some embodiments. A partitioning scheme for a key-value database may assign individual items from each table in the key-value database to a partition independent from other items in the table, in some embodiments. For example, a partitioning scheme may partition items using a distributed hashing technique that assigns hash value ranges to different partitions. Each of the partitions may store data items from different tables as the items may be assigned to any one of the partitions in the key-value database according to the hash value generated for the item, in some embodiments. In at least some embodiments, the hash values may be generated using a combination of attributes such as table identifier and key value or other identifier for the item in order to prevent items with the same value in different tables from colliding into the same location and partition in the partitioning scheme.

Obtaining an item according to a partitioning scheme for the key-value database may be performed, in various embodiments, by applying a mapping function or other partition assignment identification technique to determine which partition stores the item. Then, the partition may be accessed (e.g., by sending a request to the storage node hosting the partition, by performing an I/O operation to read the item from a storage device (e.g., disk), and/or by other action to read the item from the partition), in some embodiments. Once the first item is obtained from the partition, the first item may be returned in response to the request to obtain the item, as indicated at 630, in some embodiments. For example, the same interface, connection, protocol, or format via which the request was received may be used to return the first item in response.

Requests to obtain an item from a table that is partitioned into multi-table partitions is one of many different requests that may be performed to access the item.

FIG. 7 is a high-level flowchart illustrating various methods and techniques to perform access requests to a table stored in multi-table partitions in a key-value database, according to some embodiments. For example, as indicated at 710, a request may be received to access an item in a table of a key-value database, in some embodiments. An access request may be a request to get, read, or otherwise obtain an item, either as a request for an individual item or as part of a request that scans or queries multiple items in a table, in some embodiments. An access request may be a request to add, put, insert, or create a new item into the table, in some embodiments. An access request may be a request to delete or remove an existing item from the table, in some embodiments. An access request may be request to modify, change, update, or alter an item, in some embodiments.

As indicated at 720, a hash value may be generated from an identifier for the item and an identifier for the table, in some embodiments. For example, a hash function for the partitioning may take as input both the identifier for the item and the identifier for the table. The item identifier may be the key value (e.g., the primary key value) for the item, in some embodiments. The table identifier may be a GUID or other identifier that uniquely identifies the table with respect to other tables in the key-value database, in some embodiments (e.g., which may be mapped to the table name specified in the request). The identifiers may be combined in various fashions (e.g. concatenated, interleaved, etc.) before apply the hash function, in some embodiments. As indicated at 730, a partition of the key-value database maybe identified that is mapped to a range of hash values that includes the hash value, in some embodiments. For instance, partition mapping information may be maintained and checked to see which hash value range includes the hash value range and the pointer, identifier, network address, or other location information for accessing the partition may be included in the mapping information.

For some requests, such as a request to obtain or modify an existing item, a table index structure for the table may not be needed or modified in order to perform the request. Thus, as indicated by the negative exit from 740, performance of the access request at the identified partition may be caused, as indicated at 750, without any interaction with the table index structure, in some embodiments.

Some access requests, however, may result in a modification of the table index structure, as indicated by the positive exit from 740. For instance, access requests that add or remove items from the table may modify the table index structure, as the table index structure may identify which items belong to a particular table (as partitions may no longer indicate the contents of table as other items from other tables may be stored in a same partition, in some embodiments. Thus, as indicated at 760, update(s) to item(s) at partitions identified according to an evaluation of the table index structure may be caused to modify the table index structure. For example, an evaluation of the table index structure may indicate an operation to insert a new item representation in an existing leaf node of tree-based index structure like that discussed above with regard to FIGS. 4A and 4B. The update(s) to be caused may be a request to add an attribute that indicates the new item (e.g., a hash value and pointer to the new item). Other updates, such as updates to remove attributes to remove item representations, updates to add or remove nodes, adjust ranges, modify pointers, other operations that may be dependent upon the structure of the table index may be performed, and thus the previous examples are not intended to be limiting.

As indicated at 770, performance of the access request at the identified partition for the item may also be caused, in various embodiments. For example, the partition may be accessed (e.g., by sending a request to the storage node hosting the partition to add, insert, or delete an item, by performing an I/O operation to write or delete the item from a storage device (e.g., disk), and/or by other action to write or delete the item from the partition), in some embodiments. As indicated at 780, the updates to the index structure 760 and the performance of the access request 770 may be performed as part of a transaction at the key-value database, in some embodiments. In this way, an erroneous view of the table indicated by the table index structure without corresponding items in the table or items in the table not identified by the table index structure may not occur, in some embodiments.

For some tables stored in multi-table partitions that receive a high number of requests that access multiple table items per request (e.g., scan requests or query requests), the items that describe the table index structure may be frequently accessed, in some embodiments. In such scenarios, a cache of at least a portion of the table index structure may be maintained in order to reduce the number of interactions to evaluate the table index structure, as discussed above with regard to FIG. 342. In at least some embodiments, any portion of the index structure but the leaf node portions of the index structure may be cached (in order to ensure that leaf nodes and thus pointers to the final membership of table are never stale).

As changes to the table are made, changes to the table index structure may be incurred, in some embodiments. Cached portions of the index structure may therefore grow stale. Caching techniques to intelligently cache portions of a table index structure may be implemented in order to reduce the occurrence of stale portions of the cached index structure from affecting performing of access requests that use the table index structure. In order FIG. 8 is a high-level flowchart illustrating various methods and techniques to cache portions of an index structure for a table stored in multi-table partitions in a key-value database, according to some embodiments.

As indicated at 810, item(s) from a key-value database may be obtained that represent internal node(s) of a table index structure for a table as part of performing access request(s) to the table, in some embodiments. For example, the access requests may include requests such as scan requests or queries which may use or access the table index structure to identify which items are included in a table to perform the scan or query. In some embodiments, the access requests may include requests that change or modify the table index structure (requests to add or delete items from tables). The item(s) may be obtained for such access requests to evaluate a tree by traversing nodes in the index structure, for example.

As indicated at 820, the items may be stored in a cache for the table index structure for performing subsequent access requests to the table, in some embodiments. For example, the index object, root object, and other internal nodes may be maintained as items in the cache that can be read from the cache instead of having to send requests to storage nodes or otherwise access the items in the partition in order to evaluate the table index structure for performing access requests. When an access request for a table is received at a request routing node, for instance, the cache may be evaluated to see if any nodes of the index structure for that table are maintained in the cache. If there is a cache “hit” then the cached nodes may be evaluated first (although other nodes still have to be retrieved, for instance to get additional internal nodes that have not been previously cached).

Items in the cache may be maintained according to a cache management policy, in some embodiments. For example, cached items may be evicted if an access request is received that would invalidate the item or if the item has not been recently used (e.g., using an LRU cache management policy). In at least some embodiments, cached items may be stored along with a valid time, retention time, or other indication for determining how long an item should remain in the cache. If, as illustrated in FIG. 8, an item in the cache has exceeded its cache time limit (e.g., 10 minutes or more in the cache), then it may be removed from the cache, as indicated at 840. In this way, stale items of an index structure (e.g., which could have been updated by a different request routing node) may not slow down request processing by causing additional requests to handle discovered stale items in the cache, in some embodiments.

The methods described herein may in various embodiments be implemented by any combination of hardware and software. For example, in one embodiment, the methods may be implemented by a computer system (e.g., a computer system as in FIG. 9) that includes one or more processors executing program instructions stored on a computer-readable storage medium coupled to the processors. The program instructions may implement the functionality described herein (e.g., the functionality of various servers and other components that implement the distributed systems described herein).

The various methods as illustrated in the figures and described herein represent example embodiments of methods. The order of any method may be changed, and various elements may be added, reordered, combined, omitted, modified, etc.

Embodiments to implement multi-table partitions in a key-value database as described herein may be executed on one or more computer systems, which may interact with various other devices. One such computer system is illustrated by FIG. 9. In different embodiments, computer system 1000 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or compute node, computing device or electronic device.

In the illustrated embodiment, computer system 1000 includes one or more processors 1010 coupled to a system memory 1020 via an input/output (I/O) interface 1030. Computer system 1000 further includes a network interface 1040 coupled to I/O interface 1030, and one or more input/output devices 1050, such as cursor control device, keyboard, and display(s). Display(s) may include standard computer monitor(s) and/or other display systems, technologies or devices, in one embodiment. In some embodiments, it is contemplated that embodiments may be implemented using a single instance of computer system 1000, while in other embodiments multiple such systems, or multiple nodes making up computer system 1000, may host different portions or instances of embodiments. For example, in one embodiment some elements may be implemented via one or more nodes of computer system 1000 that are distinct from those nodes implementing other elements.

In various embodiments, computer system 1000 may be a uniprocessor system including one processor 1010, or a multiprocessor system including several processors 1010 (e.g., two, four, eight, or another suitable number). Processors 1010 may be any suitable processor capable of executing instructions, in one embodiment. For example, in various embodiments, processors 1010 may be general-purpose or embedded processors implementing any of a variety of instruction set architectures (ISAs), such as the x86,PowerPC, SPARC, or MIPS ISAs, or any other suitable ISA. In multiprocessor systems, each of processors 1010 may commonly, but not necessarily, implement the same ISA.

In some embodiments, at least one processor 1010 may be a graphics processing unit. A graphics processing unit or GPU may be considered a dedicated graphics-rendering device for a personal computer, workstation, game console or other computing or electronic device, in one embodiment. Modern GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, graphics rendering may, at least in part, be implemented by program instructions for execution on one of, or parallel execution on two or more of, such GPUs. The GPU(s) may implement one or more application programmer interfaces (APIs) that permit programmers to invoke the functionality of the GPU(s), in one embodiment.

System memory 1020 may store program instructions 1025 and/or data accessible by processor 1010, in one embodiment. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those described above are shown stored within system memory 1020 as program instructions 1025 and data storage 1035, respectively. In other embodiments, program instructions and/or data may be received, sent or stored upon different types of computer-accessible media or on similar media separate from system memory 1020 or computer system 1000. A computer-accessible medium may include non-transitory storage media or memory media such as magnetic or optical media, e.g., disk or CD/DVD-ROM coupled to computer system 1000 via I/O interface 1030. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 1040, in one embodiment.

In one embodiment, I/O interface 1030 may be coordinate I/O traffic between processor 1010, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. In addition, in some embodiments some or all of the functionality of

I/O interface 1030, such as an interface to system memory 1020, may be incorporated directly into processor 1010.

Network interface 1040 may allow data to be exchanged between computer system 1000 and other devices attached to a network, such as other computer systems, or between nodes of computer system 1000, in one embodiment. In various embodiments, network interface 1040 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1050 may, in some embodiments, include one or more display terminals, keyboards, keypads, touchpads, scanning devices, voice or optical recognition devices, or any other devices suitable for entering or retrieving data by one or more computer system 1000, in one embodiment. Multiple input/output devices 1050 may be present in computer system 1000 or may be distributed on various nodes of computer system 1000, in one embodiment. In some embodiments, similar input/output devices may be separate from computer system 1000 and may interact with one or more nodes of computer system 1000 through a wired or wireless connection, such as over network interface 1040.

As shown in FIG. 9, memory 1020 may include program instructions 1025, that implement the various embodiments of the systems as described herein, and data store 1035, comprising various data accessible by program instructions 1025, in one embodiment. In one embodiment, program instructions 1025 may include software elements of embodiments as described herein and as illustrated in the Figures. Data storage 1035 may include data that may be used in embodiments. In other embodiments, other or different software elements and data may be included.

Those skilled in the art will appreciate that computer system 1000 is merely illustrative and is not intended to limit the scope of the embodiments as described herein. In particular, the computer system and devices may include any combination of hardware or software that can perform the indicated functions, including a computer, personal computer system, desktop computer, laptop, notebook, or netbook computer, mainframe computer system, handheld computer, workstation, network computer, a camera, a set top box, a mobile device, network device, internet appliance, PDA, wireless phones, pagers, a consumer device, video game console, handheld video game device, application server, storage device, a peripheral device such as a switch, modem, router, or in general any type of computing or electronic device. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication.

Some or all of the system components or data structures may also be stored (e.g., as instructions or structured data) on a computer-accessible medium or a portable article to be read by an appropriate drive, various examples of which are described above. In some embodiments, instructions stored on a computer-readable medium separate from computer system 1000 may be transmitted to computer system 1000 via transmission media or signals such as electrical, electromagnetic, or digital signals, conveyed via a communication medium such as a network and/or a wireless link. This computer readable storage medium may be non-transitory. Various embodiments may further include receiving, sending or storing instructions and/or data implemented in accordance with the foregoing description upon a computer-accessible medium. Accordingly, the present invention may be practiced with other computer system configurations.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent example embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

What is claimed is:

1. A system, comprising:
a memory to store program instructions which, if performed by at least one processor, cause the at least one processor to perform a method to at least:
receive a request to obtain a first item from a first table of a key-value database;
responsive to the request:
apply a partitioning scheme for the key-value database to identify a first partition of a plurality of partitions of the key-value database that is assigned as a storage location for the first item, wherein a second item from a second table of the key-value database is also assigned to the first partition according to the partitioning scheme;
obtain the first item from the first partition; and
returning the first item.

2. The system of claim 1, wherein the method further causes the at least one processor to perform a method to at least:
receive a second request to access a plurality of items in the table;
responsive to the second request:
obtain respective pointers to the plurality of items in the table from a table index structure that identifies items that belong to the table; and
obtain the plurality of items from respective ones of the partitions of the key-value database identified based on the partitioning scheme and the respective pointers to perform the second request.

3. The system of claim 2, wherein to obtain the respective pointers to the plurality of items in the table from a table index structure, the method causes the at least one processor to at least evaluate one or more portions of the table index structure stored in a cache.

4. The system of claim 1, wherein the key-value database is a NoSQL database service offered as part of a provider network, wherein the plurality of partitions are stored at respective storage nodes in the provider network, wherein the request to obtain the item is received at a request routing node for the NoSQL database service, and wherein to obtain the first item from the first partition, the method causes the at least one processor to at least send a request to one of the respective storage nodes that hosts the first partition to obtain the first item.

5. A method, comprising:
responsive to a request to obtain a first item from a first table of a key-value database, returning the first item obtained from a first partition of a plurality of partitions of the key-value database that is assigned as a storage location for the first item according to a partitioning scheme for the key-value database that also assigns a second item from a second table of the key-value database to the first partition.

6. The method of claim 5, further comprising:
receiving a second request to insert the second item into the second table of the key-value database; and
responsive to the second request:
updating a table index structure that identifies items that belong to the table to add the second item; and
inserting the second item in the first partition of the plurality of partitions of the key-value database that is assigned as a storage location for the second item according to the partitioning scheme for the key-value database.

7. The method of claim 6, wherein the updating the table index structure and the inserting the second item in the first partition are performed as a transaction at the key-value database.

8. The method of claim 6, wherein the table index structure is stored as a plurality of items in the key-value database that are assigned respective storage locations among the plurality of partitions according to the partitioning scheme and wherein updating the table index structure comprises performing one or more access requests with respect to one or more of the partitions of the key-value database that stores one or more of the items of the table index structure.

9. The method of claim 5, further comprising:
receiving a second request to access a plurality of items in the table;
responsive to the second request:
obtaining respective pointers to the plurality of items in the table from a table index structure that identifies items that belong to the table; and
obtaining the plurality of items from respective ones of the partitions of the key-value database identified based on the partitioning scheme and the respective pointers to perform the second request.

10. The method of claim 9, wherein obtaining the respective pointers to the plurality of items in the table from a table index structure comprises evaluating one or more portions of the table index structure stored in a cache.

11. The method of claim 10, further comprising removing one of the portions of the table index structure from the cache that has exceeded a cache time limit for that portion.

12. The method of claim 11, wherein the table index structure is a b-tree based structure.

13. The method of claim 5, wherein the partitioning scheme for the key-value database is a distributed partitioning scheme that maps different ranges of hash values to different ones of the plurality of partitions, and wherein returning the first item obtained from a first partition of a plurality of partitions of the key-value database that is assigned as the storage location for the first item according to a partitioning scheme for the key-value database comprises:
generating a hash value for the first item based, at least in part, on an identifier for the first item and an identifier for the table; and
identifying the first partition according to the respective range of hash values mapped to the first partition that includes the generated hash value.

14. A non-transitory, computer-readable storage medium, storing program instructions that when executed by one or more computing devices cause the one or more computing devices to implement:
receiving a request to obtain a first item from a first table of a key-value database;
responsive to the request:
obtaining the first item from a first partition of a plurality of partitions of the key-value database that is assigned as a storage location for the first item according to a partitioning scheme for the key-value database that also assigns a second item from a second table of the key-value database to the first partition; and
returning the item.

15. The non-transitory, computer-readable storage medium of claim 14, wherein the program instructions cause the one or more computing devices to further implement:
receiving a second request to access a plurality of items in the table;
responsive to the second request:
obtaining respective pointers to the plurality of items in the table from a table index structure that identifies items that belong to the table; and
obtaining the plurality of items from respective ones of the partitions of the key-value database identified based on the partitioning scheme and the respective pointers to perform the second request.

16. The non-transitory, computer-readable storage medium of claim 15, wherein, in obtaining the respective pointers to the plurality of items in the table from a table index structure, the program instructions cause the one or more computing devices to implement evaluating one or more portions of the table index structure stored in a cache.

17. The non-transitory, computer-readable storage medium of claim 16, wherein the program instructions cause the one or more computing devices to further implement removing one of the portions of the table index structure from the cache that has exceeded a cache time limit for that portion.

18. The non-transitory, computer-readable storage medium of claim 14 wherein the program instructions cause the one or more computing devices to further implement:
receiving a second request to delete a third item from the first table of the key-value database; and
responsive to the second request:
updating a table index structure that identifies items that belong to the table to remove the third item; and
deleting the third item in a second partition of the plurality of partitions of the key-value database that is assigned as a storage location for the third item according to the partitioning scheme for the key-value database.

19. The non-transitory, computer-readable storage medium of claim 14, wherein the program instructions cause the one or more computing devices to further implement:
receiving a second request to update a third item from the first table of the key-value database; and
updating the third item in a second partition of the plurality of partitions of the key-value database that is assigned as a storage location for the third item according to the partitioning scheme for the key-value.

20. The non-transitory, computer-readable storage medium of claim 14, wherein the key-value database is a database service offered as part of a provider network, wherein the plurality of partitions are stored at respective storage nodes in the provider network, wherein the request to obtain the item is received at a request routing node for the database service, and wherein, in obtaining the first item from the first partition, the method causes the at least one processor to at least send a request to one of the respective storage nodes that hosts the first partition to obtain the first item.
